(19) United States
(12) Patent Application Publication
(10) Pub. No.: US 2026/0146572 A1
(43) Pub. Date: May 28, 2026

(54) SENSOR LAYOUT METHOD FOR FAULT DIAGNOSIS OF PISTON-CONNECTING ROD SYSTEM

(71) Applicants: JIANGSU UNIVERSITY OF SCIENCE AND TECHNOLOGY, Zhenjiang (CN); Jiangsu University of Science and Technology Marine Equipment and Technology Institute, Zhenjiang (CN)

(72) Inventors: Jing Xu, Zhenjiang (CN); Wei Li, Zhenjiang (CN); Jiayang Gu, Zhenjiang (CN); Bingwu Gao, Zhenjiang (CN); Xiaonan Chang, Zhenjiang (CN); Changwen Yang, Zhenjiang (CN); Xinyang Sun, Zhenjiang (CN)

(21) Appl. No.: 19/399,334

(22) Filed: Nov. 24, 2025

(30) Foreign Application Priority Data
Nov. 25, 2024 (CN) 202411689326.X

(51) Int. Cl. F02D 41/22; G06N 3/0442; G06N 3/047; G06N 3/08

(52) U.S. Cl. CPC F02D 41/22; G06N 3/0442; G06N 3/047; G06N 3/08

(57) ABSTRACT

The present disclosure provides a sensor layout method for fault diagnosis of a piston-connecting rod system in a diesel engine, including: acquiring data in each sensor layout, and obtaining a feature vector of sensors through a data preprocessing module; taking the feature vector as an input of a long short-term memory (LSTM) neural network, taking actual faulty and normal operating condition codes as an output, and performing training to obtain a fault diagnosis model; taking a test dataset as an input of the fault diagnosis model, outputting a predicted operating condition code, and performing calculation to obtain a fault diagnosis accuracy rate; taking the fault diagnosis accuracy rate and the feature vector corresponding to each sensor layout as an input of a binary Aquila optimizer-based sensor network optimization module, and taking a binary code of an optimal sensor layout as an output.

### CROSS REFERENCE TO THE RELATED APPLICATIONS

This application is based upon and claims priority to Chinese Patent Application No. 202411689326.X, filed on Nov. 25, 2024, the entire contents of which are incorporated herein by reference.

### TECHNICAL FIELD

The present disclosure relates to the field of sensor network layout optimization and fault diagnosis, and in particular to a sensor layout method for fault diagnosis of a piston-connecting rod system.

### BACKGROUND

As a key component for normal and efficient operation of the diesel engine, the piston-connecting rod system is used to efficiently convert the linear reciprocating motion of a piston into the rotational motion of a crankshaft. At present, the operating state of the piston-connecting rod system is primarily obtained through a sensor network. However, the number and positions of sensors have a significant impact on the performance and reliability of the monitoring system. Inappropriate configuration of the sensor network will increase the cost and compromise the fault diagnosis accuracy of the monitoring system.

According to the optimized layout for the sensor network in the Chinese Patent Application No. CN 116341373 A entitled “Optimized Layout Method for Sensor Network”, modal simulation analysis is performed on a structural deformation to obtain overall modal information of a structure, a number and layout positions of sensors are initialized, and a layout is optimized with an excellent local search capability of the particle swarm optimization and an excellent global search capability of the fruit fly optimization algorithm. According to the sensor network layout in the Chinese Patent Application No. CN 109751113 A entitled “Sensor Network Layout Optimization Method for Mine Microseism Monitoring and Use Thereof”, an optimization function of the sensor network layout of a wave-speed-unknown system is constructed based on a principle of a Cramer-Rao lower bound (CRLB) for optimal parameter estimation, and the optimization function is solved with an encoding operator, a selection operator, a crossover operator, a mutation operator, an elitism strategy, and a convergence criterion in the improved genetic algorithm to obtain an optimal sensor network layout. However, for the piston-connecting rod system inaccessible during operation of the diesel engine, the structural deformation cannot be simulated. Therefore, the above methods are unavailable for the piston-connecting rod system with the linear reciprocating motion.

### SUMMARY

In view of the problem that existing sensor network layouts are unsuitable for the piston-connecting rod system with the linear reciprocating motion, an objective of the present disclosure is to provide a fault diagnosis method of a sensor network system for fault diagnosis of a piston-connecting rod system, to realize accurate diagnosis on a fault in a piston and a connecting rod.

The present disclosure provides a fault diagnosis method of a sensor network system for fault diagnosis of a piston-connecting rod system, including following technical solutions:
step 1): preliminarily providing 2ⁿ−1 sensor layouts according to experience, n being a number of measured units, acquiring data of sensors in each of the 2ⁿ−1 sensor layouts, partitioning the data into a training dataset and a test dataset, and obtaining a feature vector of the sensors through a data preprocessing module;
step 2): taking the feature vector as an input of a long short-term memory (LSTM) neural network, taking actual faulty and normal operating condition codes of the piston-connecting rod system as an output, and performing training to obtain a fault diagnosis model;
step 3): taking the test dataset as an input of the fault diagnosis model, outputting a predicted operating condition code through the fault diagnosis model, and performing calculation to obtain a fault diagnosis accuracy rate for the 2ⁿ−1 sensor layouts; and
step 4): taking the fault diagnosis accuracy rate and the feature vector corresponding to each of the 2ⁿ−1 sensor layouts as an input of a binary Aquila optimizer-based sensor network optimization module, and taking a binary code of an optimal sensor layout as an output.

Further, the step 4) includes:
(1) setting parameters of a binary Aquila optimizer, randomly assigning a population size, and generating a set of random n-dimensional binary codes for individuals respectively;
(2) calculating an information entropy of a feature vector corresponding to each of the set of random n-dimensional binary codes, a proportion of sensors laid based on the random n-dimensional binary codes respectively, and fitness values;
(3) sorting the individuals according to the fitness values in a descending manner, and selecting one of the individuals with a largest fitness value as a present best position;
(4) performing position updating on a population, normalizing positions of the individuals in the population, and performing binary code mapping on normalized positions to randomly generate a set of n-dimensional [0,1] vectors, where for the normalized positions of the individuals, if a value of a dimension at the normalized positions of the individuals is less than a corresponding value of a corresponding dimension in the set of n-dimensional [0,1] vectors, the value of the dimension is set as 0, and a sensor is not provided; otherwise, the value of the dimension is set as 1, and the sensor is provided;
(5) recalculating updated fitness values for mapped positions of the individuals in the population, comparing an updated best fitness value of the population with the present best fitness value, and if the updated best fitness value of the population is better than the present best fitness value, taking an updated best position for the individuals in the population and the updated best fitness value as a present best position for the individuals in the population and the present best fitness value; and
(6) determining whether a maximum number of iterations is reached, and after the iterations are completed, taking a position of an Aquila population as the binary code of the optimal sensor layout.

Further, during the position updating performed on the population, the maximum number of the iterations is H; and if a present number h of the iterations is less than or equal to 2H/3, and a random number rand within a range of [0,1] is less than or equal to 0.5, updated positions of the individuals are:

$${X}_{1} ( h + 1 ) = {X}_{best} ( h ) \times ( 1 - \frac{h}{H} ) + ( {X}_{M} ( h ) - {X}_{best} ( h ) \times rand ) ,$$

and
if the random number rand is greater than 0.5, the updated positions of the individuals are:

$${X}_{2} ( h + 1 ) = {X}_{best} ( h ) \times Levy ( n ) + {X}_{R} ( h ) + ( p - o ) \times rand$$

where, X_{best}(h) represents a best solution till an hth iteration, X_{M}(h) represents a mean position of the population in the hth iteration, Levy (Dim) is a Levy flight distribution function, X_{R}(h) is a random solution within a range of [1, Num] in the hth iteration, Num is the population size, and p and o represent a spiral shape in search.

If a present number h of the iterations is greater than 2H/3, and a random number rand within a range of [0,1] is greater than 0.5, updated positions of the individuals are:

$${X}_{3} ( h + 1 ) = ( {X}_{best} ( h ) - {X}_{M} ( h ) ) \times α - rand + ( ( UB - LB ) \times rand + LB ) \times α ;$$

and
if the random number rand is less than or equal to 0.5, the updated positions of the individuals are:

$${X}_{4} ( h + 1 ) = QF \times {X}_{best} ( h ) - ( {G}_{1} \times X ( h ) \times rand ) - G 2 \times Levy ( n ) + rand \times {G}_{1} ,$$

where, α is an exploitation adjustment parameter set to 0.1, QF represents a quality function for balancing a search strategy, G₁ represents various motions used by a predator to track a prey in a hunting process, and G₂ represents a flight slope for tracking the prey.

By adopting the above technical solutions, the present disclosure achieves following advantages:
1) The sensor network system for fault diagnosis of a piston-connecting rod system provided by the present disclosure integrates such modules as the data preprocessing module and the binary Aquila optimizer-based sensor network optimization module, reducing the complexity of the central processing unit, and improving the reliability and cost-effectiveness of the fault diagnosis of the piston-connecting rod system.
2) Such modules as the binary Aquila optimizer-based sensor network optimization module solve the problems of long modeling time and a complex modeling process of the conventional mechanical analysis based method for providing the sensors for multi-coupled and nonlinear systems.
3) The sensor layout method for fault diagnosis of a piston-connecting rod system provided by the present disclosure takes the number of sensors, the information entropy, and the fault diagnosis rate as evaluation indexes. While ensuring the fault diagnosis rate, the present disclosure eliminates the redundant information, reduces the number of sensors and the cost, improves the monitoring precision and calculation efficiency, and guarantees the fault diagnosis accuracy.

### BRIEF DESCRIPTION OF THE DRAWINGS

FIG. 1 is a schematic structural view of a piston-connecting rod system;

FIG. 2 is a schematic diagram of force analysis on the piston-connecting rod system in FIG. 1;

FIG. 3 is a structural block diagram of a sensor layout method for fault diagnosis of a piston-connecting rod system according to the present disclosure;

FIG. 4 illustrates a binary code pattern of a sensor network;

FIG. 5 is a flowchart executed by a data preprocessing module in FIG. 3; and

FIG. 6 is a flowchart executed by a binary Aquila optimizer-based sensor network optimization module in FIG. 3.

### DETAILED DESCRIPTION OF THE EMBODIMENTS

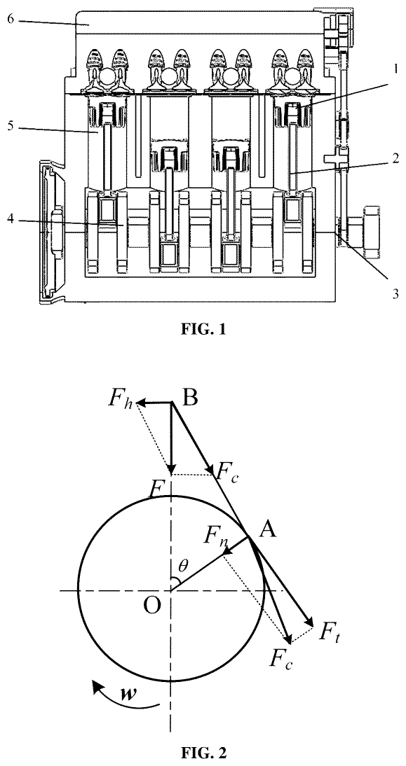

As shown in FIG. 1, a piston-connecting rod system mainly includes a piston 1, a connecting rod 2, a bearing 3, and a crankshaft 4. The piston-connecting rod system serves as a key power transmission component in a diesel engine, and its operating process includes an intake stroke, a compression stroke, a power stroke, and an exhaust stroke. As a connecting piece between the piston 1 and the crankshaft 4, the connecting rod 2 is configured to convert a linear reciprocating motion of the piston 1 into a continuous rotational motion of the crankshaft 4. The bearing 3 is located at a rotational fulcrum of crankshaft 4, ensuring smooth operation of the crankshaft 4.

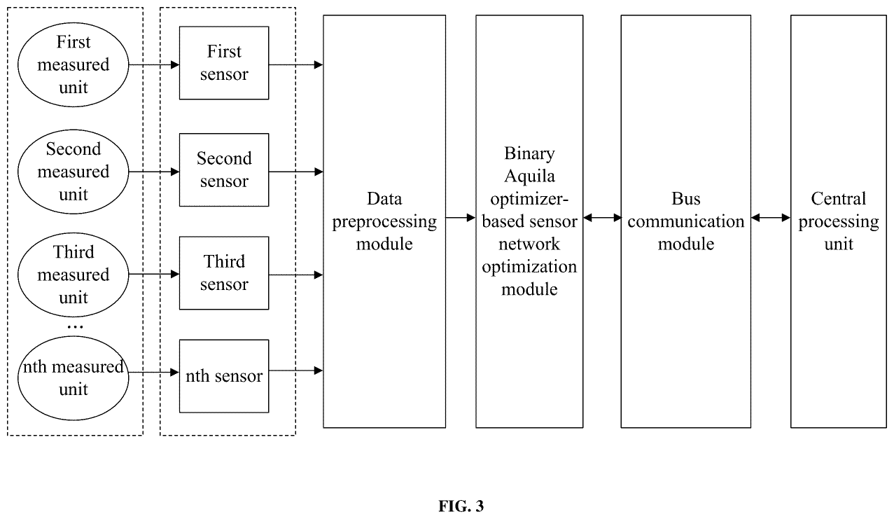

FIG. 2 shows a force diagram of the piston-connecting rod system, where the point O serves as a rotation center of the crankshaft 4, the point B serves as a center of a piston pin, and the crank OA of the crankshaft 4 makes a rotational motion. When a piston-connecting rod assembly reciprocates in a cylinder, a total force acting on the piston pin is F. Assuming that D is a diameter of a cylinder liner of the cylinder, mⱼ is a reciprocating inertial mass of the piston-connecting rod assembly, R is a radius of the crank OA, ω is an angular speed of the crank, θ is a rotation angle of the crank, λ is a ratio of the radius of the crank to a length of the connecting rod, vₕ(t) is a lateral movement speed of the piston, aₕ is a lateral acceleration of the piston, and δ is a distance from the piston to the cylinder liner, the total force F acting on the piston pin is decomposed into a horizontal force Fₕ along a horizontal direction and a force Fe along the connecting rod. The force Fₕ is a thrust of the piston on the cylinder liner:

$${F}_{h} = {m}_{j} {a}_{h} = [ \frac{π {D}^{2}}{4} P - {m}_{j} R {ω}^{2} ( cos θ + cos 2 θ ) ] \times \frac{λsinθ}{\sqrt{1 - {λ}^{2} {sin}^{2} θ}} \qquad ( 1 )$$

A lateral impact momentum Mⱼ of the piston-connecting rod assembly on the cylinder liner is obtained by:

$${M}_{j} = {m}_{j} {v}_{h} ( t ) = {m}_{j} {\int }_{0}^{t} {a}_{h} ( t ) dt \qquad ( 2 )$$

$${v}_{h} ( t ) = {\int }_{0}^{t} {a}_{h} ( t ) dt \qquad ( 3 )$$

$$δ = {\int }_{0}^{t} {v}_{h} ( t ) dt \qquad ( 4 )$$

As can be seen from above equations, the impact momentum Mⱼ of the piston-connecting rod assembly on the cylinder liner is associated with a rotational speed of the diesel engine and time t. During operation of the diesel engine, when the piston 1 reaches a top dead center, it changes a movement trend due to an inertial force. At this time, due to the change in movement direction of the piston 1 and an acting force from the piston-connecting rod assembly, a left side of the piston 1 is prone to collide with a cylinder wall. Similarly, at a bottom dead center, a right side of the piston 1 is prone to collide with the cylinder wall. Hence, based on analysis of a minimum vibration transmission path, for a wear fault in the piston ring and the cylinder liner of the single-cylinder diesel engine, at least one vibration sensor is provided on a cylinder cover for monitoring.

In case of a fault of the piston 1, the thrust F_{c} of the connecting rod 2 on the crankshaft 4 is applied to a journal center A through a center of the connecting rod 2, and can be decomposed into two mutually perpendicular forces Fₙ and Fₜ, resulting in that the bearing 3 starts to wear. As the bearing 3 wears, an effective average oil film thickness of lubricating oil decreases, and both leakage of the lubricating oil and dissipated heat increase. In addition, severe wear may lead to direct contact between a main journal and a bearing bush in a poorly lubricated area, causing an impact effect. Hence, for the single-cylinder diesel engine, in addition to the above vibration sensor, two sensors are further provided to monitor vibration and temperature changes of the bearing 3. Therefore, for an N-cylinder diesel engine, at least 3N measured units are provided.

FIG. 3 shows a diesel engine with n measured units. Each measured unit may be connected to a corresponding one of sensors. Providing each measured unit with the sensor will lead to data redundancy and increased system complexity, thereby affecting rapid and accurate acquisition of key information. Therefore, the present disclosure provides a sensor layout method for fault diagnosis of a piston-connecting rod system, to realize a more efficient and accurate monitoring function.

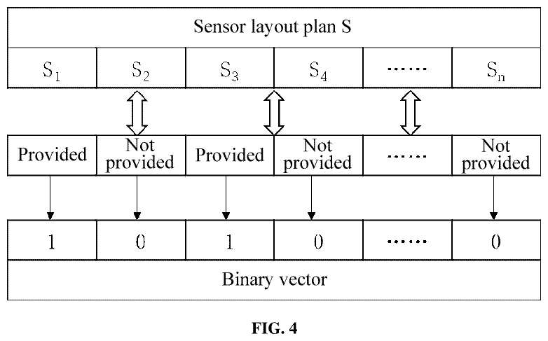

As shown in FIG. 4, the sensor layout problem can be regarded as a combinatorial binary optimization problem. Whether each measured unit is provided with the sensor can be represented by a binary vector Vectors=(S₁, S₂, . . . , Sₙ). Elements S₁, S₂, . . . , Sₙ in the vector represent the measured units. Sᵢ—0 indicates that the ith measured unit is not provided with the sensor. Conversely, Sᵢ=1 indicates that the ith measured unit is provided with the sensor (1≤i≤n).

Specifically, taking the N-cylinder diesel engine as an example, based on the above empirical analysis on FIGS. 1-2, in order to monitor the piston-connecting rod system, there are at least 3N measured units, 3N≤n, and 2ⁿ−1 sensor layouts. According to the above empirical analysis, sensors are preliminarily provided. In each sensor layout, data of the sensors are acquired. After the data is calculated by a data preprocessing module, a binary code of an optimal sensor layout is searched with a binary Aquila optimizer-based sensor network optimization module. The binary code is transmitted to a central processing unit via a bus communication module, and reversely parsed by the central processing unit to determine the optimal sensor layout, as shown in FIG. 3.

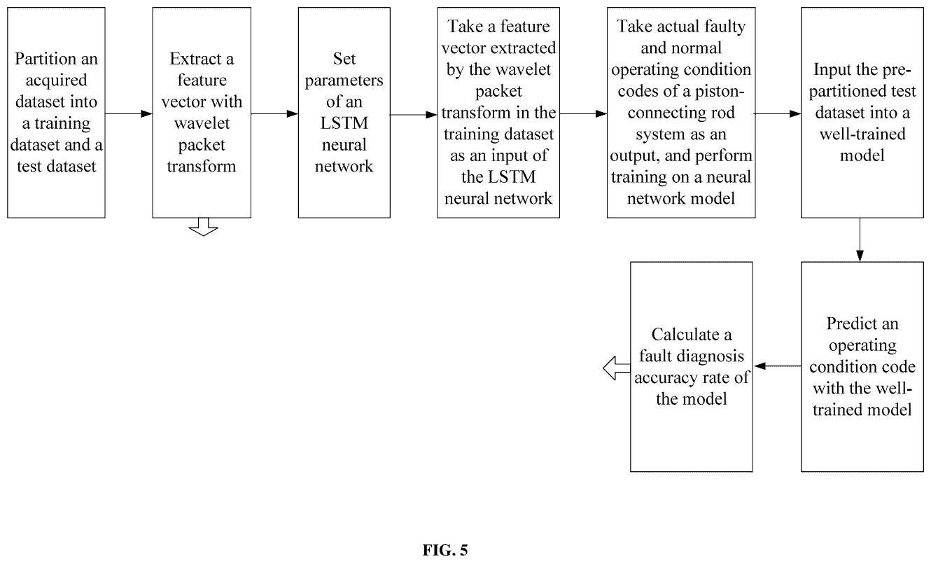

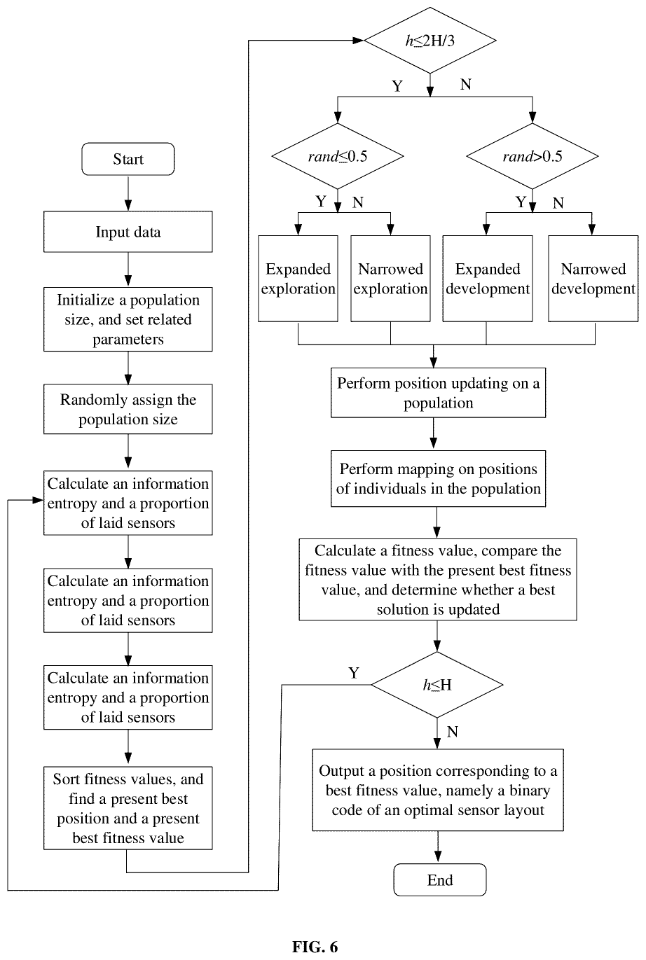

FIG. 5 shows a data preprocessing process. In the 2ⁿ−1 sensor layouts, the data acquired by the sensors is taken as an input, and a fault diagnosis accuracy rate and a feature vector are taken as an output. Operating conditions of the sensors in each sensor layout are acquired to obtain s faulty and normal operating conditions. Corresponding actual faulty and normal operating condition codes are 1, 2, . . . , s. 200 samples are acquired for each operating condition, and 200×s m-dimensional samples are acquired, m being a number of sensors in the present sensor layout. 80% of the data in the 200×s m-dimensional samples is used as a training dataset, and remaining 20% of the data is used as a test dataset. Then, three-level decomposition is performed on the data acquired by the sensors in the training dataset and the test dataset with wavelet packet transform to obtain eight frequency bands. An energy entropy for signals in the eight frequency bands is calculated as a feature vector of the sensors to form an 8×m-dimensional feature vector Z(z₁, z₂, . . . , z_{8×m}). The feature vector Z(z₁, z₂, . . . , z_{8×m}) is extracted. The feature vector Z(z₁, z₂, . . . , z_{8×m}) is taken as an input of an LSTM neural network and the binary Aquila optimizer-based sensor network optimization module.

In the LSTM neural network, the initial learning rate is set to 0.01, the initial learning rate is adjusted after 60 training epochs, the learning rate decay factor is 0.2, the regularization parameter is 0.001, and the maximum number of training epochs is 100. At last, the 8×m dimensional feature vector of the training set is used as the input of the LSTM neural network, while the actual faulty and normal operating condition codes 1, 2, . . . , s of the piston-connecting rod system are used as an output. With sufficient training, a fault diagnosis model is obtained. Then, the pre-partitioned test dataset is used as the input, and a predicted operating condition code is output by the fault diagnosis model. Finally, the fault diagnosis accuracy rate F(2ⁿ−1) for the 2ⁿ−1 sensor layouts is calculated by Eq. (5):

$$F ( {2}^{n} - 1 ) = \frac{d}{200 \times s} \times 100 \% . \qquad ( 5 )$$

where, d represents a number of samples with the predicted operating condition code being different from the actual faulty and normal operating condition codes 1, 2, . . . , s during verification of the test dataset.

The fault diagnosis accuracy rate F(2ⁿ−1) is input to the binary Aquila optimizer-based sensor network optimization module.

FIG. 6 shows a flowchart of the binary Aquila optimizer-based sensor network optimization module. The 2ⁿ−1 sensor layouts are built in the binary Aquila optimizer-based sensor network optimization module. The binary Aquila optimizer-based sensor network optimization module takes the fault diagnosis accuracy rate F(2ⁿ−1) and the feature vector corresponding to each layout as the input, and the binary code of the optimal sensor layout as the output. Specifically:
(1) Parameters of a binary Aquila optimizer are set: A population size is set as Num, a maximum number of iterations is set as H, a number of dimensions of a population and a number of measured units are the same and are n, an upper bound is set as UB, and a lower bound is set as LB, and positions of Aquila individuals are randomly initialized.
(2) The population size is randomly assigned, and a set of random n-dimensional binary codes are generated for the individuals respectively, namely for positions of the individuals. The positions of the individuals in the population are a set of n-dimensional vectors. At this time, this set of n-dimensional vectors is the set of random n-dimensional binary codes.
(3) An information entropy G(2ⁿ−1) of a feature vector corresponding to each of the set of random n-dimensional binary codes is calculated by Eq. (6):

$$G ( {2}^{n} - 1 ) = - {\sum }_{i = 1}^{8 \times m} P ( {z}_{e} ) {log}_{2} P ( {z}_{e} ) \qquad ( 6 )$$

where, for the feature vector Z(z₁, z₂, . . . , z_{8×m}), P(zₑ) is a probability distribution of a state zₑ, and the probability distribution P(zₑ) is calculated by Eq. (7):

$$P ( {z}_{e} ) = \frac{\vert {z}_{e} \vert}{{\sum }_{j = 1}^{8 \times m} \vert {z}_{j} \vert} \qquad ( 7 )$$

where, zⱼ is eigenvalues corresponding to different dimensions of the feature vector, j=1, 2, . . . , 8×m.
(4) A proportion of sensors laid based on the random n-dimensional binary codes respectively is calculated by Eq. (8):

$$K ( {2}^{n} - 1 ) = m / n \qquad ( 8 )$$

(5) Fitness values fit(2ⁿ−1) are calculated based on the proportion K(2ⁿ−1) of the sensors laid based on the random n-dimensional binary codes respectively, the fault diagnosis accuracy rate F(2ⁿ−1), and the information entropy G(2ⁿ−1) by Eq. (9), to evaluate performance of the individuals in the population:

$$fit ( {2}^{n} - 1 ) = 2 - F ( {2}^{n} - 1 ) - G ( {2}^{n} - 1 ) + K ( {2}^{n} - 1 ) \qquad ( 9 )$$

(6) The individuals are sorted according to the fitness values fit(2ⁿ−1) in a descending manner, one of the individuals with a largest fitness value is selected as a present best position X_{fit}, and the largest fitness value is selected as a present best fitness value fit.
(7) A position of the population is updated. If a present number h of iterations is less than or equal to 2H/3, and a random number rand within a range of [0,1] is less than or equal to 0.5, expanded exploration X₁ is performed. This is equivalent to explore a search space globally to find a possible solution area. The algorithm can quickly identify a potential area with a best solution within a larger range. A specific update Eq. (10) is as follows:

$${X}_{1} ( h + 1 ) = {X}_{best} ( h ) \times ( 1 - \frac{h}{H} ) + ( {X}_{M} ( h ) - {X}_{best} ( h ) \times rand ) \qquad ( 10 )$$

where, X₁(h+1) represents positions of the individuals updated by a first search method in an (h+1)th iteration of the Aquila optimizer, namely the expanded exploration X₁, X_{best}(h) represents a best solution till an hth iteration, X_{M}(h) represents a mean position of the population in the hth iteration, H represents the maximum number of iterations, and rand is the random number in the range of [0,1].
(8) If the present number h of iterations is less than or equal to 2H/3, and the random number rand is greater than 0.5, narrowed exploration X₂ is performed. This step indicates that after a potential solution is found, the algorithm performs local search in the region more intensively to approach the best solution. A specific update Eq. (11) is as follows:

$${X}_{2} ( h + 1 ) = {X}_{best} ( h ) \times Levy ( n ) + {X}_{R} ( h ) + ( p - o ) \times rand \qquad ( 11 )$$

where, X₂(h+1) represents positions of the individuals updated by a second search method in the (h+1)th iteration of the Aquila optimizer, namely the narrowed exploration X₂, Levy(Dim) is a Levy flight distribution function, n is the number of dimensions of the population, X_{R}(h) is a random solution of the hth iteration in a range [1, Num], and p and o represent a spiral shape in the search.
(9) If the present number h of iterations is greater than 2H/3, and the random number rand is greater than 0.5, expanded development (X₃) is performed. This indicates that the algorithm will adopt a more meticulous and sluggish method to gradually approach the best solution. A specific update Eq. (12) is as follows:

$${X}_{3} ( h + 1 ) = ( {X}_{best} ( h ) - {X}_{M} ( h ) ) \times α - rand + ( ( UB - LB ) \times rand + LB ) \times α \qquad ( 12 )$$

where, X₃(h+1) represents positions of the individuals updated by a third search method (X₃) in the (h+1)th iteration of the Aquila optimizer, and @ is an exploitation adjustment parameter set to 0.1.
(10) If the present number h of iterations is greater than or equal to 2H/3, and random number rand is less than or equal to 0.5, narrowed development X₄ is performed. The algorithm performs final fine-tuning and verification to ensure that a genuine best solution is found. A specific update Eq. (13) is as follows:

$${X}_{4} ( h + 1 ) = QF \times {X}_{best} ( h ) - ( {G}_{1} \times X ( h ) \times rand ) - G 2 \times Levy ( n ) + rand \times {G}_{1} \qquad ( 13 )$$

where, X₄(h+1) represents positions of the individuals updated by a fourth search method in the (h+1)th iteration of the Aquila optimizer, namely the narrowed development X₄, QF represents a quality function for balancing a search strategy, G₁ represents various motions used by a predator to track a prey in a hunting process, and G₂ represents a flight slope for tracking the prey.
(11) After the population is updated completely, the positions of the individuals in the population are normalized by Eq. (14):

$$T ( {X}_{b} ( h + 1 ) ) = \frac{1 - sin ( {X}_{b} ( h + 1 ) )}{2} \qquad ( 14 )$$

where, X_{b}(h+1) represents positions of the individuals updated by a bth search method in the (h+1)th iteration of the Aquila optimizer (b=1, 2, 3, or 4), and the updated positions of the individuals in the population are normalized as T(X_{b}(h+1)). At this time, the positions of the individuals each are an n-dimensional vector within (0-1).
(12) Binary code mapping is performed on the normalized positions T(Xᵥ(h+1)) s by Eq. (15) to randomly generate a set of n-dimensional [0,1] vectors r; in the normalized positions T(X_{b}(h+1)) of the individuals, the positions of individuals are respectively compared with the random vectors r, and if a value of a dimension at the normalized positions of the individuals is less than a corresponding value of a corresponding dimension in the vectors r, the value of the dimension is set as 0, and the sensor is not provided; otherwise, the value of the dimension is set as 1, and the sensor is provided:

$${X}_{ij} = \{ \begin{matrix}1 , & if r < T ( {X}_{b} ( h + 1 ) ) \\ 0 , & else\end{matrix} \qquad ( 15 )$$

where, Xᵢⱼ represents mapped positions of the individuals in the population.
(13) Updated fitness values are calculated with the steps (3-5) for the mapped positions of the individuals in the population. At this time, the positions of the individuals are mapped as a set of binary codes. The fitness values are sorted to find an updated best position for the individuals in the population and a corresponding fitness value. The updated best fitness value of the population is compared with the present best fitness value fit. If the updated best fitness value of the population is better than the present best fitness value fit, the updated best position for the individuals in the population and the corresponding fitness value are respectively taken as a present best position for the individuals in the population and the present best fitness value.
(14) Whether the maximum number of iterations H is reached is determined. If yes, the iteration is stopped. If no, the steps (3) to (13) are repeated.
(15) Upon completion of the iteration, the position of the Aquila population is the binary code of the optimal sensor network.

The code of the optimal sensor layout is transmitted to the central processing unit through the bus communication module, and reversely parsed by the central processing unit to determine the sensor layout, thereby improving the monitoring precision.

What is claimed is:

1. A sensor layout method for fault diagnosis of a piston-connecting rod system, comprising following steps:
step 1): preliminarily providing 2ⁿ−1 sensor layouts, n being a number of measured units, acquiring data of sensors in each of the 2ⁿ−1 sensor layouts, partitioning the data into a training dataset and a test dataset, and obtaining a feature vector of the sensors through a data preprocessing module;
step 2): taking the feature vector as an input of a long short-term memory (LSTM) neural network, taking actual faulty and normal operating condition codes of the piston-connecting rod system as an output, and performing training to obtain a fault diagnosis model;
step 3): taking the test dataset as an input of the fault diagnosis model, outputting a predicted operating condition code through the fault diagnosis model, and performing calculation to obtain a fault diagnosis accuracy rate for the 2ⁿ−1 sensor layouts; and
step 4): taking the fault diagnosis accuracy rate and the feature vector corresponding to each of the 2ⁿ−1 sensor layouts as an input of a binary Aquila optimizer-based sensor network optimization module, and taking a binary code of an optimal sensor layout as an output.

2. The sensor layout method for the fault diagnosis of the piston-connecting rod system according to claim 1, wherein in the step 1), operating conditions of the sensors in each of the 2ⁿ−1 sensor layouts are acquired to obtain s faulty and normal operating conditions; corresponding actual faulty and normal operating condition codes are 1, 2, . . . , s; 200 samples are acquired for each of the s faulty and normal operating conditions, and 200×s m-dimensional samples are acquired in total, m being a number of the sensors in a present sensor layout; and 80% of the data in the 200×s m-dimensional samples is taken as the training dataset, and remaining 20% of the data is taken as the test dataset; and
three-level decomposition is performed on the data acquired by the sensors in the training dataset and the test dataset with wavelet packet transform to obtain eight frequency bands; an energy entropy for signals in the eight frequency bands is calculated as the feature vector of the sensors to form an 8×m-dimensional feature vector.

3. The sensor layout method for the fault diagnosis of the piston-connecting rod system according to claim 2, wherein in the step 3), the fault diagnosis accuracy rate is calculated by
$$F ( {2}^{n} - 1 ) = \frac{d}{200 \times s} \times 100 \% .$$
d representing a number of samples with the predicted operating condition code being different from the actual faulty and normal operating condition codes 1, 2, . . . , s during verification of the test dataset.

4. The sensor layout method for the fault diagnosis of the piston-connecting rod system according to claim 1, wherein the step 4) comprises:
(1) setting parameters of a binary Aquila optimizer, randomly assigning a population size, and generating a set of random n-dimensional binary codes for individuals respectively;
(2) calculating an information entropy of a feature vector corresponding to each of the set of random n-dimensional binary codes, a proportion of sensors laid based on the random n-dimensional binary codes respectively, and fitness values;
(3) sorting the individuals according to the fitness values in a descending manner, and selecting one of the individuals with a largest fitness value as a present best position;
(4) performing position updating on a population, normalizing positions of the individuals in the population, and performing binary code mapping on normalized positions to randomly generate a set of n-dimensional [0,1] vectors, wherein for the normalized positions of the individuals, when a value of a dimension at the normalized positions of the individuals is less than a corresponding value of a corresponding dimension in the set of n-dimensional [0,1] vectors, the value of the dimension is set as 0, and a sensor is not provided; otherwise, the value of the dimension is set as 1, and the sensor is provided;
(5) recalculating updated fitness values for mapped positions of the individuals in the population, comparing an updated best fitness value of the population with the present best fitness value, and when the updated best fitness value of the population is better than the present best fitness value, taking an updated best position for the individuals in the population and the updated best fitness value as a present best position for the individuals in the population and the present best fitness value; and
(6) determining whether a maximum number of iterations is reached, and after the iterations are completed, taking the position of an Aquila population as the binary code of the optimal sensor layout.

5. The sensor layout method for the fault diagnosis of the piston-connecting rod system according to claim 4, wherein in the step (2), the information entropy is calculated by
$$G ( {2}^{n} - 1 ) = - {\sum }_{i = 1}^{8 \times m} P ( {z}_{e} ) {log}_{2} P ( {z}_{e} ) ,$$
wherein P(zₑ) is a probability distribution of a state zₑ, and
$$P ( {z}_{e} ) = \frac{\vert {z}_{e} \vert}{{\sum }_{j = 1}^{8 \times m} \vert {z}_{j} \vert} ,$$
zⱼ being eigenvalues corresponding to different dimensions of the feature vector, j=1, 2, . . . , 8×m, and m being a number of the sensors in a present sensor layout.

6. The sensor layout method for the fault diagnosis of the piston-connecting rod system according to claim 5, wherein the proportion of the sensors laid based on the random n-dimensional binary codes respectively is calculated by K(2ⁿ−1)=m/n.

7. The sensor layout method for the fault diagnosis of the piston-connecting rod system according to claim 6, wherein the fitness values are calculated by: fit(2ⁿ−1)=2−F(2ⁿ−1)−G(2ⁿ−1)+K(2ⁿ−1), F(2ⁿ−1) being the fault diagnosis accuracy rate.

8. The sensor layout method for the fault diagnosis of the piston-connecting rod system according to claim 4, wherein in the step (4), during the position updating performed on the population, the maximum number of the iterations is H; and when a present number h of the iterations is less than or equal to 2H/3, and a random number rand within a range of [0,1] is less than or equal to 0.5, updated positions of the individuals are:
$${X}_{1} ( h + 1 ) = {X}_{best} ( h ) \times ( 1 - \frac{h}{H} ) + ( {X}_{M} ( h ) - {X}_{best} ( h ) \times rand ) ,$$
and
when the random number rand is greater than 0.5, the updated positions of the individuals are:
$${X}_{2} ( h + 1 ) = {X}_{best} ( h ) \times Levy ( n ) + {X}_{R} ( h ) + ( p - o ) \times rand ,$$
wherein, X_{best} (h) represents a best solution till an hth iteration, X_{M}(h) represents a mean position of the population in the hth iteration, Levy(Dim) is a Levy flight distribution function, X_{R}(h) is a random solution within a range of [1, Num] in the hth iteration, Num is the population size, and p and o represent a spiral shape in search.

9. The sensor layout method for the fault diagnosis of the piston-connecting rod system according to claim 4, wherein in the step (4), during the position updating performed on the population, the maximum number of the iterations is H; and when a present number h of the iterations is greater than 2H/3, and a random number rand within a range of [0,1] is greater than 0.5, updated positions of the individuals are:
$${X}_{3} ( h + 1 ) = ( {X}_{best} ( h ) - {X}_{M} ( h ) ) \times α - rand + ( ( UB - LB ) \times rand + LB ) \times α ;$$
and
when the random number rand is less than or equal to 0.5, the updated positions of the individuals are:
$${X}_{4} ( h + 1 ) = QF \times {X}_{best} ( h ) - ( {G}_{1} \times X ( h ) \times rand ) - G 2 \times Levy ( n ) + rand \times {G}_{1} ,$$
wherein, α is an exploitation adjustment parameter set to 0.1, QF represents a quality function for balancing a search strategy, G₁ represents various motions used by a predator to track a prey in a hunting process, and G₂ represents a flight slope for tracking the prey.

10. The sensor layout method for the fault diagnosis of the piston-connecting rod system according to claim 8, wherein after the position updating, the positions of the individuals in the population are normalized by
$$T ( {X}_{b} ( h + 1 ) ) = \frac{1 - sin ( {X}_{b} ( h + 1 ) )}{2} ,$$
wherein X_{b}(h+1) represents positions of the individuals updated by a bth search method in an (h+1)th iteration of the binary Aquila optimizer, b=1, 2, 3, or 4, and the positions of the individuals each are an n-dimensional vector in (0-1).

11. The sensor layout method for the fault diagnosis of the piston-connecting rod system according to claim 9, wherein after the position updating, the positions of the individuals in the population are normalized by
$$T ( {X}_{b} ( h + 1 ) ) = \frac{1 - sin ( {X}_{b} ( h + 1 ) )}{2} ,$$
wherein X_{b}(h+1) represents positions of the individuals updated by a bth search method in an (h+1)th iteration of the binary Aquila optimizer, b=1, 2, 3, or 4, and the positions of the individuals each are an n-dimensional vector in (0-1).
